(19) United States
(12) Patent Application Publication
(10) Pub. No.: US 2002/0077916 A1
(43) Pub. Date: Jun. 20, 2002

(54) Business to business internet web site

(76) Inventor: Robert C. Greene, Clifton, VA (US)

Correspondence Address: Richard C. Litman, LITMAN LAW OFFICES, LTD., P.O. Box 15035, Arlington, VA, 22215, US

(21) Appl. No.: 09/735,911

(22) Filed: Dec. 14, 2000

Related U.S. Application Data
(60) Provisional application No. 60/170,532, filed on Dec. 14, 1999.

(51) Int. Cl. G06F 17/60

(52) U.S. Cl. 705/26

(57) ABSTRACT

A system and method for conducting business to business e-commerce transactions between manufacturers of consumer products and retailers. The retailer generally requests product information, the manufacturer usually provides product information, and the website commonly processes and stores the product information. The novel feature of the business to business website includes the method by which information is accessed, processed, and stored between various retailers and manufacturers over the Internet.

### CROSS-REFERENCE TO RELATED APPLICATION

This application claims the benefit of U.S. Provisional Patent Application Serial No. 60/170,532, filed Dec. 14, 1999.

### BACKGROUND OF THE INVENTION

1. Field of the Invention

The present invention relates to a system and method for conducting business to business e-commerce transactions between manufacturers of consumer products and retailers.

2. Description of Related Art

Updating mail order catalogues and other catalogue systems have prompted the technological generation to design new inexpensive and efficient ways to improve the older system. Free-standing catalogue kiosk machines in retail stores have replaced printed catalogues because they are easier and less expensive to update. One significant disadvantage to a catalogue system available through kiosk machines is that the same information is available to everyone and not tailored to meet the needs of individual consumers.

Several types of electronic catalogue systems are known in the related art. The following patents describe different types of electronic catalogue systems, security-related identifications systems, and various mainframe database systems.

U.S. Pat. No. 5,319,542, issued to King, Jr., et al. on Jun. 7, 1994, discloses a system for ordering items using an electronic catalog. This electronic catalogue system is run on a mainframe computer with satellite computers or PC's tied to the mainframe computer. The heart of the system consists of two database types maintained on the mainframe and a third database type which can be created and maintained on the satellites computers. The mainframe databases include a Supplier Master Catalog, created by various product suppliers with a Public Catalog database and a Private Catalog database. The customer orders items from the Public Catalog or creates his own Private Catalog on his satellite computer consisting of categories of items from the Public Catalog. There are various file maintenance programs and procurement function programs that pass data between the databases and out to the user.

U.S. Pat. No. 5,664,110, issued to Jonathan B. Green, et al. on Sep. 2, 1997, describes a remote ordering system which uses inventory databases, a computer to format and transfer data called a data format/transfer computer (DFTC) , and user devices called generically display/processor units (DPU's) to create and transmit order lists. The DPU's are comprised of a screen that have touch command capabilities, a port for attachment of a bar-code reader, and memory for storing product/service information. The DPU's random access memory (RAM) is used to create and store a database of items the user can order, as well as to build a list of the user's order. The DPU communicates with the merchants' catalogue databases through the DFTC. The DFTC accesses the merchants' databases through a variety of avenues, including the Internet. The DFTC can also provide advertising for a particular merchant or merchandise back to the user DPU. This system uses identification control cards which provide user and merchant names and addresses to the system through the DCU or through the DFTC.

U.S. Pat. No. 5,715,448, issued to Suzuki, et al. on Feb. 3, 1998, describes an open database system wherein access by subscribers to a network is limited. The system seeks to better balance supply and demand for various types of textiles for the apparel industry based on an analysis of demand based on sales. A master database containing precise information from textile manufacturers, apparel manufacturers, and apparel marketing companies is stored on a master database. Access to the database is limited to certain subscribers and the data entered is protected so that individual entity data is not available to other subscribers to protect proprietary information provided by each individual subscriber. This system, while having an ordering component, is more of a forecasting tool specifically tailored to the textile industry and the production and sale of apparel.

U.S. Pat. No. 5,721,832, issued to Westrope, et al. on Feb. 24, 1998, describes a method and apparatus for an interactive computerized catalog system. Consumers access a catalog in electronic form stored in or accessed by a central mainframe computer. The method of access is over commercial telephone lines and a video terminal is connected to the mainframe computer by telephone lines. The system seems to be oriented towards trade across the US/Canadian border. This system would allow for the creation of a customer profile database with customer permission, and a way to compute commissions to hotels and other public facilities from which consumer orders originated.

U.S. Pat. No. 5,732,400, issued to Mandler, et al. on Mar. 24, 1998, discloses a system and method for the risk-based purchase of goods. This system is centered on an automated financial clearing house. The automated clearinghouse reviews a purchaser's credit history file then establishes a payment amount to the seller from the clearing house with an appropriate risk-based discount based on purchaser's credit history. The automated clearinghouse also handles the payments to the seller and from the buyer, as well as the ability to tie a broker into the system for processing and filling the orders. This system would operate using the Internet, and a local area network (LAN) or a wide area network (WAN). This invention utilizes a credit analysis system to determine a purchaser's credibility in their system.

U.S. Pat. No. 5,787,428, issued to Keith Hart on Jul. 28, 1998, discloses a database access system using a security/user tag correspondence table. This invention is a database that incorporates a security tag operation which allows access to the data appropriate to that particular security identifier. The system maintains the identification information separately from the actual databases but unlocks the database by means of a security tag field within the database.

U.S. Pat. No. 5,790,677, issued to Fox, et al. on Aug. 4, 1998, discloses a system and method for securing electronic commerce (e-commerce) transactions. The system seeks to achieve the traditional goals of authenticity, integrity, privacy, and security in the exchange of commercial documents in an electronic setting. The ease of accessibility to electronic systems through the personal computer necessitates an electronic means of preventing document alteration, forgery and other potentially deceptive practices. This system establishes a credential authority which also acts as a credential binding server. Encrypted identification packets containing participant digital signatures are registered with the credential binding server. The trusted authority sends authenticating packets bearing its electronic signature to each participant, who can then communicate directly with one another with encrypted documents whose authenticity is validated by the electronic signature of the trusted authority. Encryption procedures are such that only the intended recipient can open and decipher the document.

U.S. Pat. No. 5,802,497, issued to Mark S. Manasse on Sep. 1, 1998, discloses a method and apparatus for conducting computerized commerce on a number of computer systems connected by a computer network. The system provides a broker computer system having a database of broker scrips each representing a form of electronic currency. There is also a vendor computer system having a database containing products which may be exchanged for the broker scrips.

U.S. Pat. No. 5,813,006, issued to Polnerow, et al. on Sep. 22, 1998, describes an on-line directory service with a registration system. The on-line directory has a large number of records that are publicly accessible through a website. The directory also has a registration system for users. Registered users can make edits to their listings and obtain other services.

U.S. Pat. No. 5,826,268, issued to Schaefer et al. on Oct. 20, 1998, describes a secure multilevel object oriented database management system which maintains data confidentiality and optimizes data integrity. This system has an access validation monitor responsible for determining if access control is allowable, and for detecting unauthorized access. A semantic vector is used to indicate each property of a multilevel object and the vector will mark each of these properties.

U.S. Pat. No. 5,857,188, issued to Jeffrey G. Douglas on Jan. 5, 1999, describes a management system of client requests in a client-server environment. This is a method, apparatus, and article of manufacture for monitoring and regulating access to a database. Requests for the database are intercepted and evaluated against one or more restrictions established by a database administrator for the database and generating an indication signal representative of the evaluation. The intercepted requests are rejected or allowed in accordance with the indication signal.

U.S. Pat. No. 5,903,882, issued to Asay, et al. on May 11, 1999, describes a reliance server for an electronic transaction system. This is a method of managing reliance in an electronic transaction system which includes a certification authority issuing a primary certification to a subscriber and forwarding to a reliance server the information about the issued primary certificate. The reliance server maintains the forwarded information about the issued primary certificate. The subscriber forms a transaction and then provides the transaction to a relying party. The relying party sends to the reliance server a request for assurance based on the transaction received from the subscriber. The reliance server determines whether to provide the requested assurance based on the information about the issued primary certificate and on the requested assurance.

Germany Pat. No. 2,257,200, issued on June of 1974, describes a credit risk assessment system. The invention is based on the proposition that the probability value for credit risk can be calculated from individual criteria or negative credit decision characteristics relating to the applicant for credit.

Many of the above-discussed systems still experience a variety of problems associated with the speed and costs of business to business transactions over the Internet or other forms of electronic commerce.

Businesses exchanging marketing resources occurring during business transactions sometimes end in disaster. The expenses alone associated with expending marketing resources and making informed credit decisions may keep many corporations from exploiting the vast number of small business retailers. Another problem with most business websites are that they do not allow manufacturers access to the stored databases to update information at any time the manufacturers shall choose.

None of the above inventions and patents, taken either singly or in combination, is seen to describe the instant invention as claimed.

### SUMMARY OF THE INVENTION

The present invention is a system and method for conducting business to business e-commerce transactions between manufacturers of consumer products and retailers. The retail consumer generally requests product information, the manufacturer usually provides product information, and the website commonly processes and stores the product information. The principal novel feature of the business to business website includes the method by which information is accessed, processed, and stored between various retailers and manufacturers over the Internet.

Accordingly, it is a principal object of the invention to provide a business to business method that eliminates the lengthy and costly process of printing and distributing mass mailings of catalogues.

It is another object of the invention to provide a browsable Internet system whereby specific product information can be downloaded by a retail consumer onto a personal computer.

It is a further object of the invention to provide manufacturers with accessible databases containing credit profiles and product information which can be immediately updated by the manufacturer and eliminates the need for a broker.

Still another object of the invention is to provide a business to business website that includes a site accessing system that requires the user to submit their membership identification code in order to gain access to product information.

It is an object of the invention to provide improved elements and arrangements thereof a method for a business to business website in a system for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of the operation of the business to business website according to the present invention.

FIG. 2 is a flow chart of a preferred method for conducting the business to business website of the present invention.

FIG. 3 is a flow chart of a preferred method for conducting the business to business website between retailers and manufactures of the present invention.

FIG. 4 is a flow chart of a preferred method for conducting the business to business website between retailers and manufactures of the present invention.

Similar reference characters denote corresponding features consistently throughout the attached drawings.

### DETAILED DESCRIPTION OF THE PREFERRED EMBODIMENT

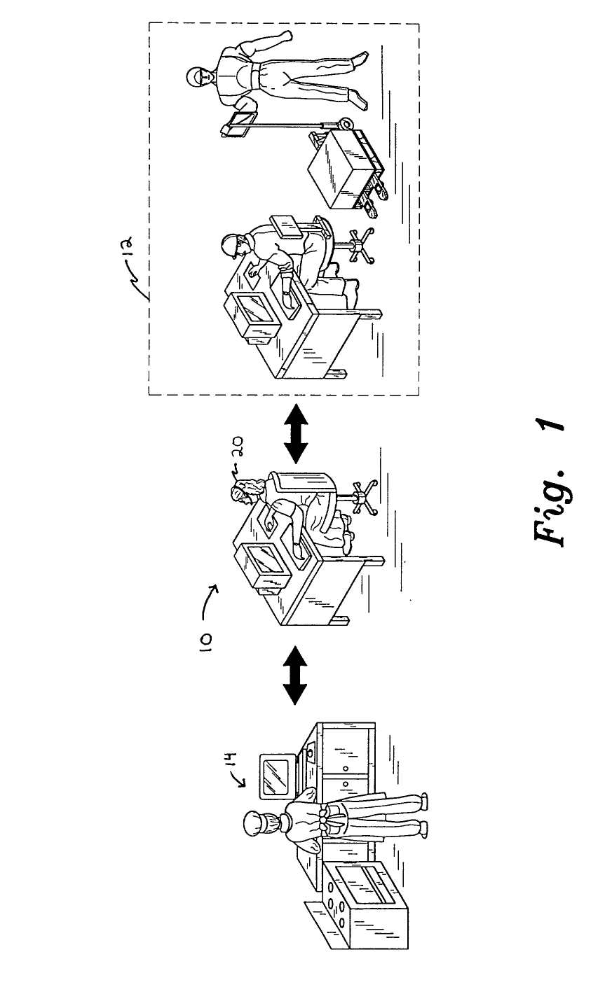

The present invention is a system and method for conducting business to business e-commerce transactions between manufacturers 12 of consumer products and retailers 14 and designated as 10 in the drawings. An environmental view of an Internet model for implementing the method is shown in FIG. 1.

The retailer (customer or consumer) 14, the website and website administrator 10, and manufacturer 12 each have specific roles to perform in the business to business website 10. The retail consumer 14 generally requests product information, the manufacturer 12 usually provides product information, and the website 10 commonly processes and stores the product information. The novel feature of the business to business website 10 includes the method by which information is accessed, processed, and stored between various retailers 14 and manufacturers 12 over the Internet.

Preferably, the method 10 begins by the website administrator creating a web page that includes an announcement of the business to business website 10 specifically designed for retailers 14 and manufacturers 12. The business to business website 10 includes a personalized login access system whereby a retailer 14 and manufacturer 12 of a consumer product can log onto specific information stored and\or provided by each business entity involved.

Each retailer 14 and manufacturer 12 is assigned a personalized membership identification code which allow them access to specific information within the business to business website 10. The business to business website administrator is the designated person responsible for managing all official transactions conducting on through the website.

The business to business website 10 includes real time customer service staff 20 that operates to solve customer questions, requests, and complaints. This method for business to business e-commerce transactions 10 allows a retailer 14 to log onto the website and access specific information stored on the website system through information provided by the manufacturer 12.

The webpage is preferably created by using conventional means, such as a commercially available web page designer and a keyboard. The website may be designed such that various information about the retailers 14 and manufactures 12 will be available to each other through a personalized access login code.

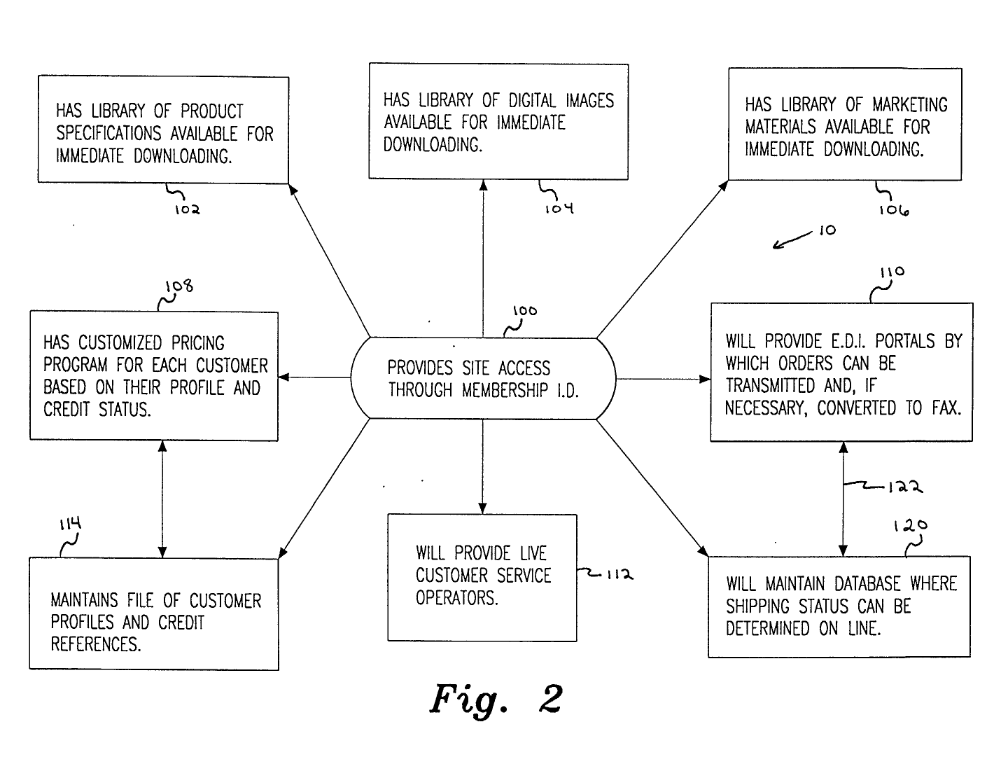

FIG. 2 illustrates the main operation of the business to business website 10. First, the business to business browsable website 10 provides a site accessing system 100 where through membership identification codes for retailers 14 or manufacturers 12 are used to gain access to specific information stored onto the website. The browsable website 10 possesses downloadable libraries 102, 104, and 106 of production information, pricing information 108, has an Electronic Data Interference (E.D.I.) portal for ordering 110, a real time on-line customer service 112, and maintains files of customer profiles and credit references 114, and maintains shipping status information 120 which is specific to the membership identification used when logging onto the website. Once logged on to the system, the retailer or manufacturer can choose from several business to business e-commerce transactions provided by the website.

There are at least three libraries 102, 104, and 106 containing information which is available for immediate downloading. The first library 102 includes product specifications available to retailers for immediate downloading. The second library 104 includes digital images of product information available to retailers for immediate downloading. The third library 106 includes marketing materials to retailers for immediate downloading. These libraries 102, 104, and 106 contain stored information for browsing and specifically designed to only be available to retailers and manufacturers according to their personalized access login codes.

There is at least one customized pricing program 108 for each customer based on their profile and credit status 114. Once logged onto the system, the website allows a retailer access to a pricing program 108 stored through the website which is customized to each retailer based on profile and credit status 114. The website maintains files of customer profiles and credit references 114 for manufacturers with which each retailer desires to do business. A retailer provides a customer profile and credit history where it is stored onto the website mainframe 114. The retailer determines what manufacturers can obtain access to the credit information and at the same time prevent anyone from accessing the information. Each retailer supplies the credit information needed in order for the desired manufacturer to access that specific information.

There is an (E.D.I.) portal 110 by which orders can be transmitted and, if necessary, converted to fax. The (E.D.I.) portal 110 is a one source contact for generating, receiving, and storing orders and is linked 122 to the database that stores shipping status information 120. The website will maintain a database where shipping statuses 120 can be determined on-line. This information can be accessed only by certain membership identification codes which are issued to a retailer or manufacturer.

A customer service oriented staff 112 will also be available on the business to business website 10. An on-line real time customer service staff 112 will be provided to help solve customer questions, requests, and complaints. Customer service 112 would also provide additional communicational options to contact customer service such as an e-mail option and a toll free number for telephone callers.

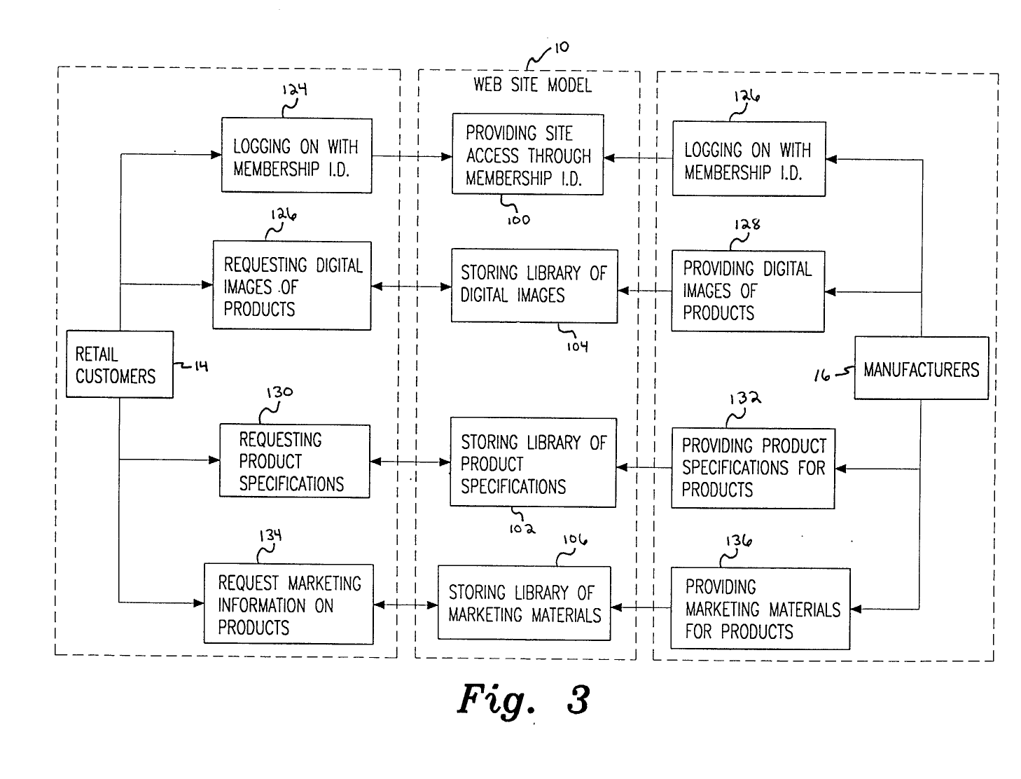

FIG. 3 illustrates the method of operation of the business to business website 10 whereby retailers 14 and manufacturers 12 accessing libraries 102, 104, and 106 of information in order to conduct business over the Internet. First, the website provides a site accessing system 100 that requires the users to submit their membership identification code before any transaction can be initiated. The retailer 14 or manufacturer 12 accomplishes this by logging 124 and 126 into the business to business website 10 using their personalized membership identification code issued to them by the website administrator. The membership identification code only allows the user access to certain databases of information specific to their membership identification code.

Once logged 124 into the business to business website 10, a retailer 14 may request access to digital images of products 126 which have been provided by various manufacturers. Each manufacturer provides 128 the website with separate downloadable libraries of catalogued digital images of their products only available to certain retailers 14 which are identified by their membership identification code. All the catalogued digital images of products are provided by each manufacturer 128 and is stored as part of the digital images library 104 in the business to business website 10 mainframe. As a result, a retailer 14 may access 126 a variety of digital images of products stored 104 in libraries tailored to their credit profiles. Manufacturers are able to upgrade the digital images 128 immediately for less cost than it would be to print a new catalogue or distribute in a flyer.

The retailer 14 may further request product specifications 130 from certain manufacturers 12. Each manufacturers 12 will provide 132 the website with product specifications tailored to meet the information provided by the retailer's credit profile and credit references. All the product specifications information supplied by each manufacturer 132 will be stored within the product specifications libraries 102 in the business to business website 10 mainframe. Manufacturers 12 are able to upgrade the product specifications immediately for less cost than it would be to print a new catalogue or distribute in a flyer.

Retailers 14 may also request marketing information 134 on various products made or supplied by certain manufacturers. Each manufacturers 12 will provide 136 the website with marketing information about their products specific based on the retailer's credit profile. All marketing information provided by each manufacturer will be stored 106 on the business to business website 10 mainframe. Manufacturers 12 are able to upgrade the marketing information immediately for less cost than it would be to print a new catalogue or distribute in a flyer.

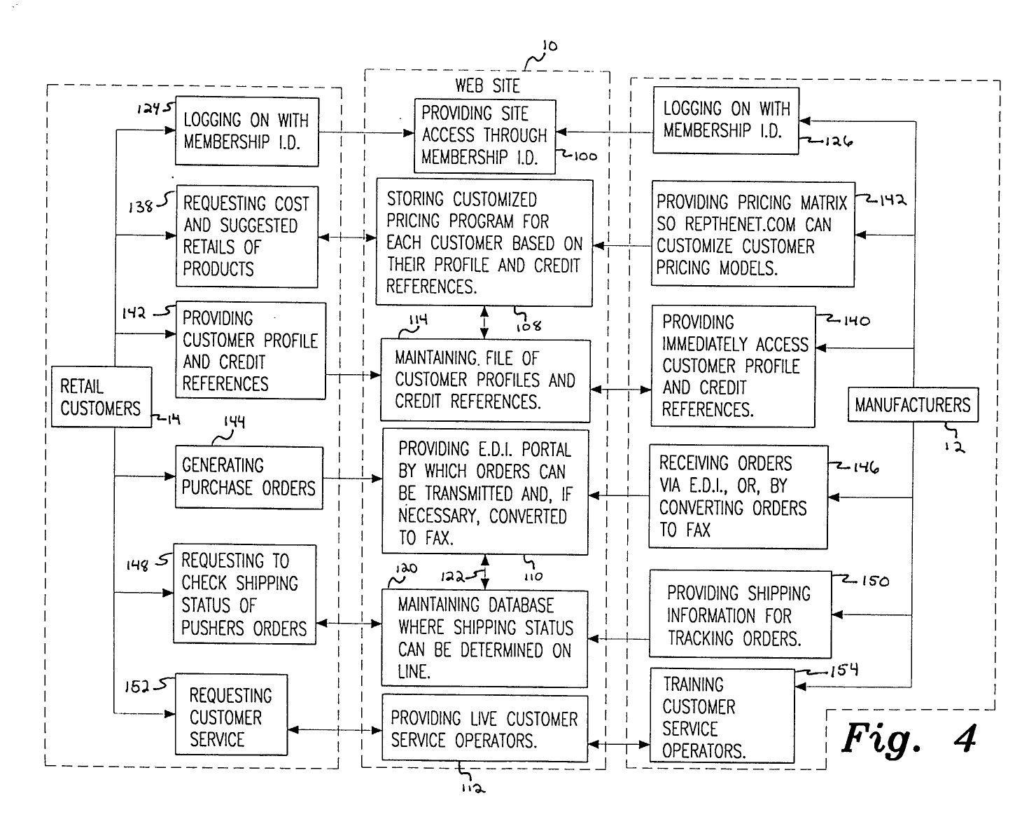

FIG. 4 illustrates the method of operation the business to business website 10. Operations include: providing, accessing, and storing pricing information; providing, storing, and accessing customer profiles and credit references; generating, storing, and receiving purchase orders; requesting, providing, and storing shipping status information; and having an available on-line customer service staff. FIG. 4 is a continuation of the method of operation of the business to business website 10 in FIG. 3. Again, the business to business website 10 provides a site accessing system 100 that requires the users 124 and 126 to submit their membership identification code. The retailer 14 or manufacturer 12 must then log onto the business to business website 10 using their personalized membership identification code. Almost all transactions done through the business to business website 10 are secured through the membership identification code specific to each retailer and manufacturer.

Once logged 124 onto the business to business website 10, a retailer 14 may request 138 pricing information of various products offer by certain manufacturers. In order for a retailer 14 to gain access to various pricing information, most manufacturers 12 request a customer profile of the potential retailer and credit references. The business to business website administrator maintains 114 all customer profiles including their credit status. Retailers 14 must approve which manufacturers 12 can gain access to their customer profile information 140 which is accomplished through the membership identification codes. The business to business website 10 would incorporate security and anti-hacking programs into the website's mainframe so that information like credit profiles would be secure.

A retailer 14 may request 138 cost and suggested retails of certain products from various manufacturers 12. Each manufacturer 12 provides 142 the business to business website 10 with separate pricing matrixes based on the retailer's submitted 142 customer profile and credit status. All the catalogued pricing matrixes will be provided 142 by each manufacturer 12 and is stored 108 onto the business to business website mainframe.

As a result, the retailer 14 would provide 142 customer profile and credit references to the administrator of the business to business website where the information is stored and maintained 114. Each manufacturer 12 that the retailer requests to provide pricing matrixes would have immediate access to the information provided by the retailer. The manufacturer 12 would tailor their pricing matrixes to accommodate the retailer according to the approved credit profiles submitted 142. Finally, the manufacturer 12 would provide 142 the requested to the pricing information specific to each retailer 14 and the website administrator would provide the approved downloadable pricing matrix 108 from various manufacturers.

The next step after reviewing pricing matrixes provided 142 by specific manufacturer 12 would be for the retailer 14 to order 144 specific products listed in the pricing matrix 108. The business to business website 10 provides an (E.D.I.) portal 110 by which orders can be transmitted and, if necessary, the order forms can be converted for faxing. The manufacturers 12 would receive 146 the orders via the (E.D.I.) portal 110, or, the converted orders by fax.

Once an order has been received 146 by the specified manufacturer 12, the shipping status of the products ordered can be requested 148 by the retailers through their membership identification. Each manufacturer would provide 150 the business to business website with updated shipping status information on the products ordered 144 by each retailer. The shipping information would be constantly updated and stored 120 on the website by the website's administrator or manufacturer. The (E.D.I.) portal 110 may be directly linked 122 to the shipping status information to provide an instant status report indicating exactly when an order has been generated 144. Customer service 112 would also have access to the shipping information 120 in order to assist both retailers and manufacturers in any non-confidential information that need to be accessed.

A customer service staff 112 will also be available through the business to business website. There are several ways to approach the customer service option 112 through the business to business website. One option may be to reach an on-line real time customer service staff who will provide 112 help in solving consumer questions, requests, and complaints. Some other additional ways to access 152 the customer service staff would be through e-mail, fax, and a toll free number for telephone callers.

Customer service staff 112 would always have access to all information on the business to business website in order to assist both retailers and manufacturers in any non-confidential information which they may need assistance in accessing. Customer service's identification codes would act like a master key. The manufacturer's would train 154 the customer service operators with specific knowledge in order to assist retailers.

The mass mailings of catalogued products listed by manufacturers to potential customers is administratively burdensome, labor intensive, and costly. Browsing through the numerous catalogues that are distributed every year by various manufacturers and filling out order form is a very long process. The business to business website eliminates the lengthy and costly process of printing and distributing mass mailings of catalogues. The present invention also eliminates the need for a broker to process and fill orders between retailers and manufacturers.

Another advantage to the business to business website is the manufacturers can update databases of information immediately and without the cost of reprinting catalogues. Specific marketing and product information condensed into one library can be downloaded onto a personal computer which is specific to the retailers credit profile. A specific downloadable library of product information saves the retail consumer a lot of time which was previously spent browsing through a mass number of catalogues from different manufacturers.

It is to be understood that the present invention is not limited to the sole embodiment described above, but encompasses any and all embodiments within the scope of the following claims.

I claim:

1. A method and system for conducting business to business e-commerce transactions between manufacturers of consumer products and retailers through a website mainframe located on the Internet, comprising the steps of:
(a) providing a site accessing system whereby users can gain access to specific information stored onto the website mainframe which is specific to each retailer and manufacturer;
(b) storing and maintaining libraries of product information provided by manufacturers, wherein each said library is compiled to a specific customer profile, wherein each said library is accessible to a specific membership identification code;
(c) storing and maintaining files of customer profiles and credit references which is accessible to manufacturers approved by the retailer consumers who provided the customer profiles and credit references;
(d) thereafter storing customized pricing programs on the website mainframe for each customer to access based on their profile and credit status;
(e) providing and maintaining an E.D.I. portal by which products can be ordered, orders can be generated through the E.D.I. portal by customers, and orders can be received through the E.D.I. portal by manufacturers;
(f) thereafter maintaining a database where the shipping status of all orders can be determined, wherein the shipping status is accessible to customers through their membership identification code; and
(g) providing an on-line real time customer service staff which is trained by manufacturers who are members of the business to business website.

2. A method and system for conducting business to business e-commerce transactions in claim 1, further comprising in step (a), the user having a membership identification login code which gives each manufacturer or retailer access to specific information.

3. A method and system for conducting business to business e-commerce transactions in claim 1, wherein the maintained libraries of product information in step (b) include producing digital images, of products provided by manufacturers.

4. A method and system for conducting business to business e-commerce transactions in claim 1, wherein the maintained libraries of product information in step (b) include producing product specifications provided by manufacturers.

5. A method and system for conducting business to business e-commerce transactions in claim 1, wherein the maintained libraries of product information in step (b) include providing marketing information on products provided by manufacturers.

6. A method and system for conducting business to business e-commerce transactions in claim 1, wherein the files of customer profiles and credit references in step (c) are limited in access to manufacturers approved by the requesting customer.

7. A method and system for conducting business to business e-commerce transactions in claim 1, wherein each customized pricing program in step (d) is provided by a manufacturer for a specific customer identified by the membership code.

8. A method and system for conducting business to business e-commerce transactions in claim l wherein E.D.I. portal in step (e) can be converted as necessary to a facsimile.

9. A method and system for conducting business to business e-commerce transactions in claim 1, wherein the shipping status of all orders in step (f) is provided by manufacturers for tracking purposes.

10. A method and system for conducting business to business e-commerce transactions in claim 1, further providing a representative of said customer service in step (g) which is an on-line real time customer service operator.

11. A method and system for conducting business to business e-commerce transactions in claim 1, wherein said customer service in step (g) is accessed by e-mail.

12. A method and system for conducting business to business e-commerce transactions in claim 1, wherein said customer service in step (g) is accessed by a telephone.
